(19) United States
(12) Patent Application Publication
(10) Pub. No.: US 2004/0021686 A1
(43) Pub. Date: Feb. 5, 2004

(54) Method and system for collaborative interaction on a document

(76) Inventor: Romain P. Barberis, Dasmarinas Village (PH)

Correspondence Address: BAKER & MCKENZIE, 805 THIRD AVENUE, NEW YORK, NY, 10022, US

(21) Appl. No.: 10/208,690

(22) Filed: Jul. 30, 2002

(51) Int. Cl. G09G 5/00

(52) U.S. Cl. 345/738

(57) ABSTRACT

Disclosed is a system to permit corroboration and interaction among individuals over an electronic network. The system maintains a database of changes, both textual and graphical, that each user makes to a document in the database. The system can also create a single page that shows the entire history of the document, including each textual and graphical changes that a user made, together with that users' comments, mark-ups, etc. The document can be a web page that the user selects from any web server located on the network.

### TECHNICAL FIELD

The present disclosure relates to a system and method for providing a method and system to enable programmers, designers, clients, and others to collaborate and interact in designing documents that may contain textual or graphical content, or both.

### BACKGROUND OF THE INVENTION

More often than not more than one person is involved in creating intellectual property, whether it is an article, advertisement or web page. Software developers have attempted to ease the corroboration and interaction among these individuals. For example, Adobe Acrobat®, a widely available software product, permits users to comment on a document and to exchange comments using sticky notes, a highlight pen, and other touch-up tools. A user can also use his/her local Acrobat® program to access a document that is stored on a server, mark-up that document, and upload the mark-up to the server for access by other users.

However, in addition to the above features it would be desirable for a user to change the document itself and to maintain a database of the changes both textual and graphical that each user made to the document. Also desirable would be the ability to create a single page that shows the entire history of the document, including each textual and graphical change that a user made, together with that users' comments, mark-ups, etc. A product that enables a user to browse any single web page located on any web server in the world and share comments, assign tasks, request for validation or make graphical annotations on the displayed web page would also be helpful.

### BRIEF DESCRIPTION OF THE DRAWINGS

FIG. 1(a) illustrates the login screen.

FIG. 1(b) illustrates the forgot password retrieval screen.

FIG. 2 illustrates the user's Personal Homepage screen.

FIG. 3 illustrates the “My Profile” Screen.

FIG. 4(a) illustrates the “My Inbox” screen.

FIG. 4(b) illustrates the read message screen.

FIG. 4(c) illustrates the “Reply” screen.

FIG. 4(d) illustrates the “Select Message Recipients” screen.

FIG. 4(e) illustrates the “Forward” “screen.

FIG. 4(f) illustrates the “Compose New Message” and “Select Message Recipients” screens.

FIG. 4(g) illustrates the “Sent Messages” screen.

FIG. 5(a) illustrates “My Projects” screen.

FIG. 5(b) illustrates “My Projects” screen with the “Collaboration Platform” pane fully open.

FIG. 6(a) illustrates in detail the “My Tasks” frame of FIG. 2.

FIG. 6(b) illustrates the “Confirm Change Status” screen.

FIG. 7 illustrates the “For My Validation” frame.

FIG. 8(a) illustrates the “Tasks I Assigned” frame.

FIG. 8(b) illustrates the “Assign New Task” screen.

FIG. 9 illustrates the “Validations I Requested” frame.

FIG. 10 illustrates the browser within the browser screen displaying a particular task.

FIG. 11 illustrates the “Project” screen with the “Add Comments” function activated.

FIG. 12(a) illustrates the browse for file window.

FIG. 12(b) illustrates an image loaded into a window by means of the browse for file window of FIG. 12(a).

FIG. 12(c) illustrates the window of FIG. 12(b) with the Freez n' Draw feature activated.

FIG. 13 illustrates the “Project” screen with the “Add Comments” function activated and comment added.

FIG. 14 illustrates the “Project” screen with the “Select Validation Request Recipients” function activated.

FIG. 15 illustrates the “Project” screen with the “Freez n' Draw” function activated.

FIG. 16 illustrates the “Project” screen with the “Freez n' Draw” function activated and a web page with markup.

FIG. 17 illustrates the “Project” screen with the “Send Email Notification” function activated.

FIG. 18 illustrates the “Page Status Report” window.

FIG. 19 illustrates the “Page States Report” window with the screen capture displayed.

FIG. 20 illustrates a window showing the upper portion of the “Site Status Report”.

FIG. 21 illustrates a window showing the lower portion of the “Site Status Report”.

FIG. 22 illustrates the “Site Status Report” window with the “More Option” drop down menu activated.

### DETAILED DESCRIPTION

The method and system described below aid in developing documents through collaborative interaction between designers, developers, and customers. As used in this specification and claims documents has the broadest meaning known to those skilled in the art. For example, it includes not only web pages, but also files in memory, in streams, or on fixed storage.

The illustrative embodiment described below shows a web site that lists a set of projects in which the user participates. A user then selects the project in which the user is interested and a list of tasks or comments associated with that project appears. A web page associated with the project is then displayed in what appears to be a “browser within a browser.” Although this embodiment is implemented using Microsoft Internet Explorer, sometimes referred to as “IE”, one skilled in the art recognizes that other programs could also be employed in the stead or in addition to IE.

In this new window, the user can browse any new page on the web. By clicking on the appropriate button, the user can add a comment that becomes associated with that particular page. That comment, together with the associated web page, joins the list of comments and tasks. Any user with access can view the comment and its associated web page or associated file. Although the illustrated embodiment uses “buttons” that are represented by icons suggestive of the functions associated with the buttons, a person skilled in the art recognizes other mechanisms, such as hotkeys or shortcuts, can be used to activate the appropriate function.

By selecting another button, the user can freeze the page and actually mark up that page using the provided tools. The marked up page, and its associated comments, becomes another item in the list of comments and tasks. The freeze feature works also with animated files, such as those produced by Macromedia Flash®, or video files to capture a single frame for mark up and comment. Local files, such as those stored on the hard drive of the user's computer, for example, Word® documents, Excel® Spreadsheets, PDF® files, as well as any image files (GIFs, JPEGs, PNGs, etc . . . ), may also be marked up using the same freeze feature and shared with other users. Another button activates the site status feature. This feature displays on a single page suitable for emailing or printing each comment and task with its associated web page.

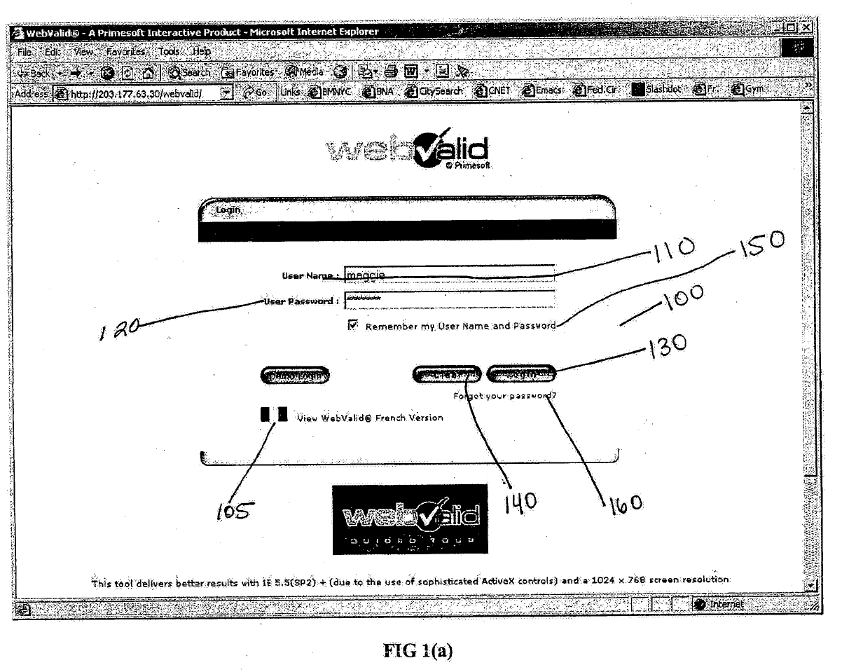

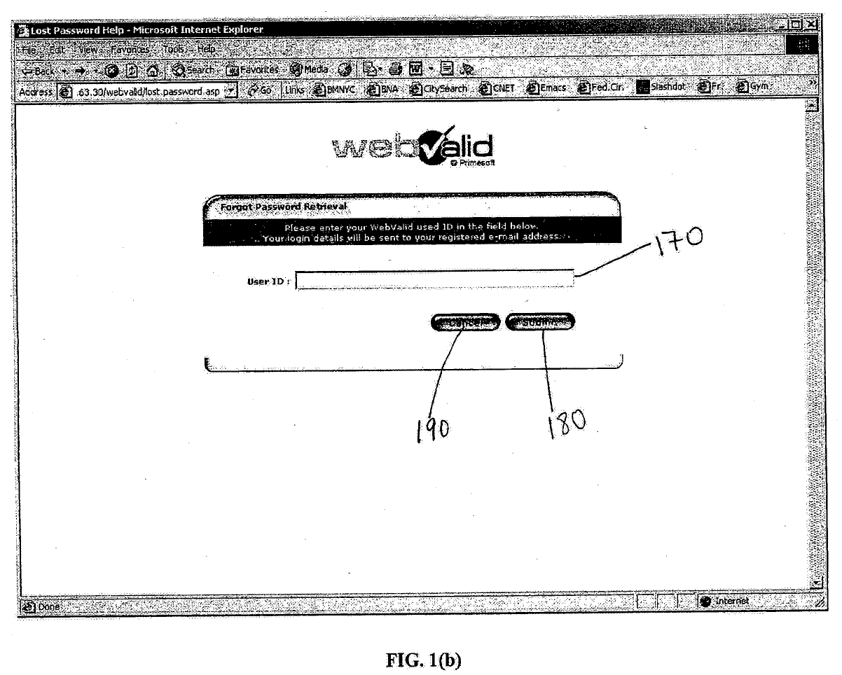

FIG. 1(a) illustrates the “Login” screen. First time users are prompted to select a default language to be used for all sessions. If the user wishes to switch to another language, the user may do so by clicking button 105. The user logs on by entering his/her username in field 110 and the password in field 120 and clicking “Login” button 130. If the user makes an error in username or password entry, clicking on “Clear” button 140 will clear the entry. For increased security, no two people can login simultaneously using the same username/password access codes. In the event that this happens, the second user will be unable to login for several minutes, for example, a period of 15 minutes.

The system also includes a way to remember the user's login details. To enable this feature, the user clicks “Remember my Username and Password” checkbox 150 after entering the login details. In the event that the user has forgotten his/her password, the user may click on “Forgotten Your Password” button 160, upon which event a password retrieval screen will be displayed, as shown in FIG. 1(b). Upon entering the User ID in field 170 and clicking on “Submit” button 180, the user's login details will be sent via-email to the registered e-mail address. The user may cancel the “Forgot Password Retrieval” screen by clicking on “Cancel” button 190.

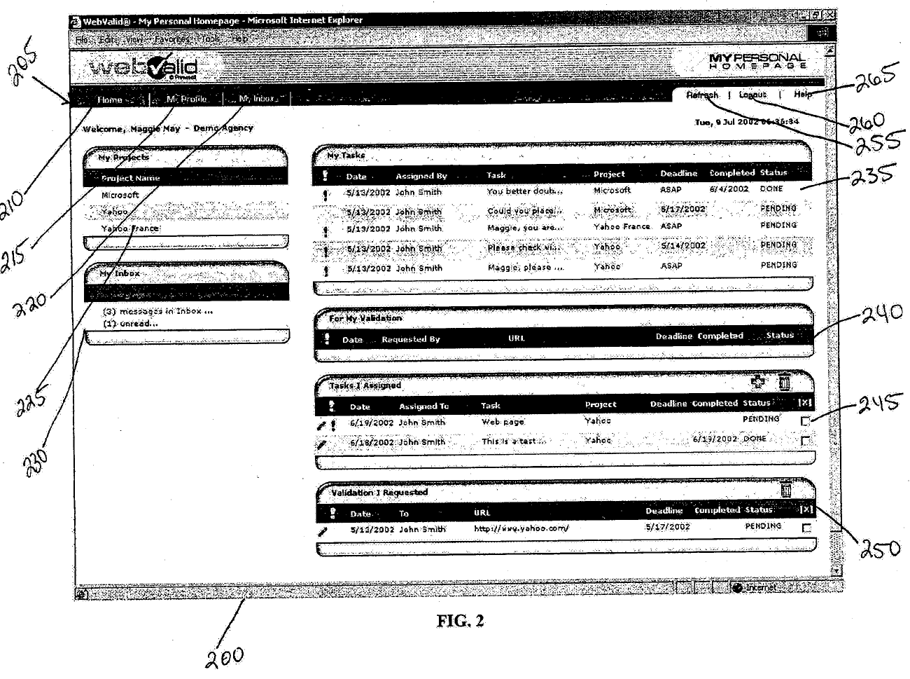

FIG. 2 displays the user's “Personal Homepage” window 200 that appears after login. This page summarizes the activities associated with the particular user. The navigation menu 205 displays three buttons: “Home” button 210, “My Profile” button 215, and “My Inbox” button 220. “My Projects” frame 225 displays the user's projects. “My Inbox” frame 230 displays various messages awaiting the user. “My Tasks” frame 235 lists the various task that the user has or should accomplish. “For My Validation” frame 240 lists various pages that the user has been asked to validate. “Tasks I Assigned” frame 245 lists that tasks that the user assigned. “Validations I Requested” frame 250 lists the validations that the user requested others to make.

“Refresh” button 255 causes a redisplay of the page. “Logout” button 260 logs the user off the site hosting the illustrated embodiment. “Help” button 265 activates the on-line help system.

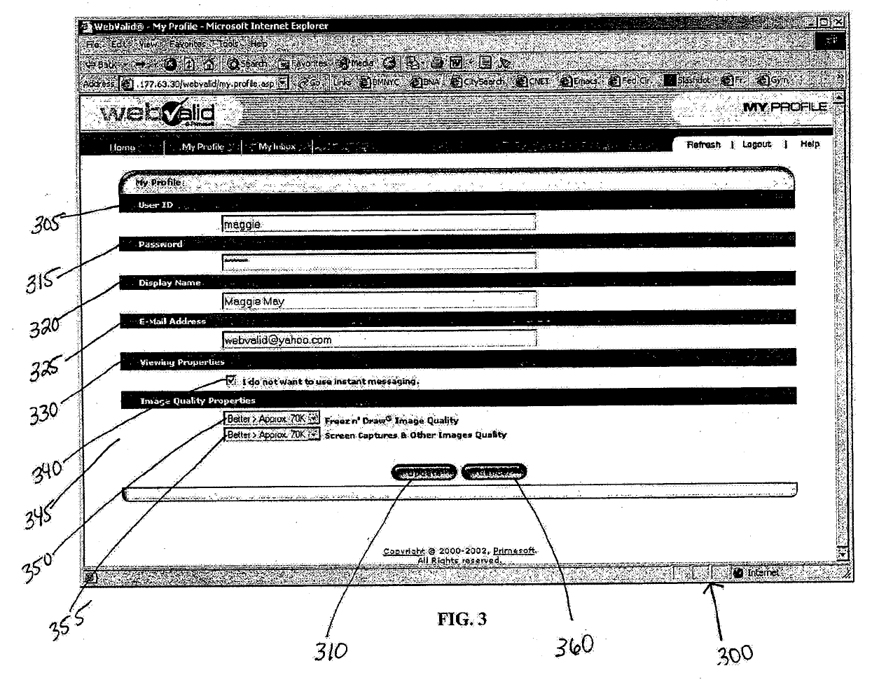

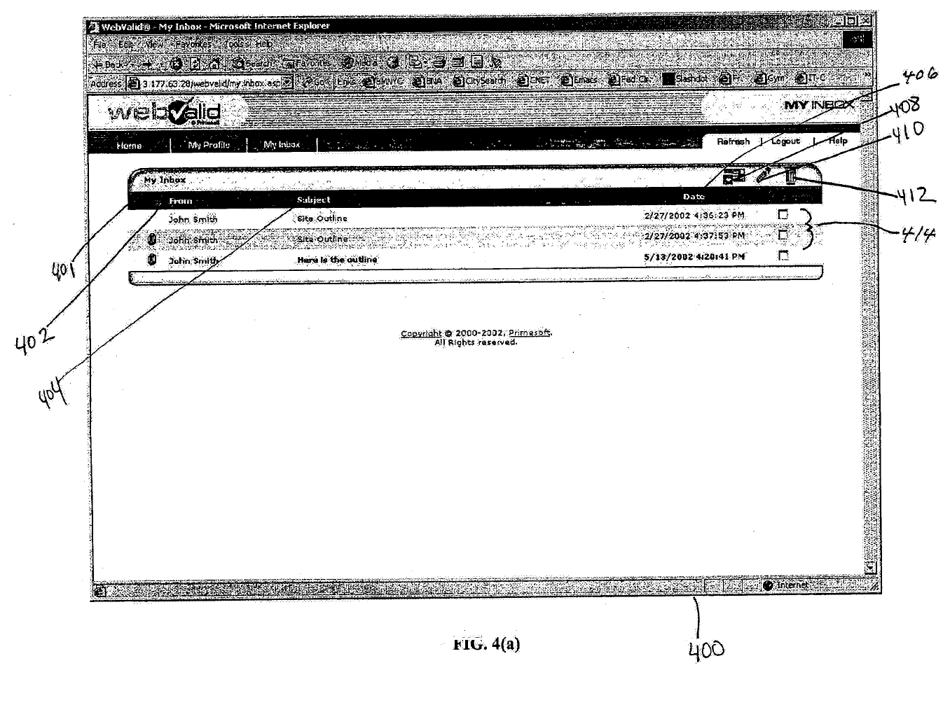

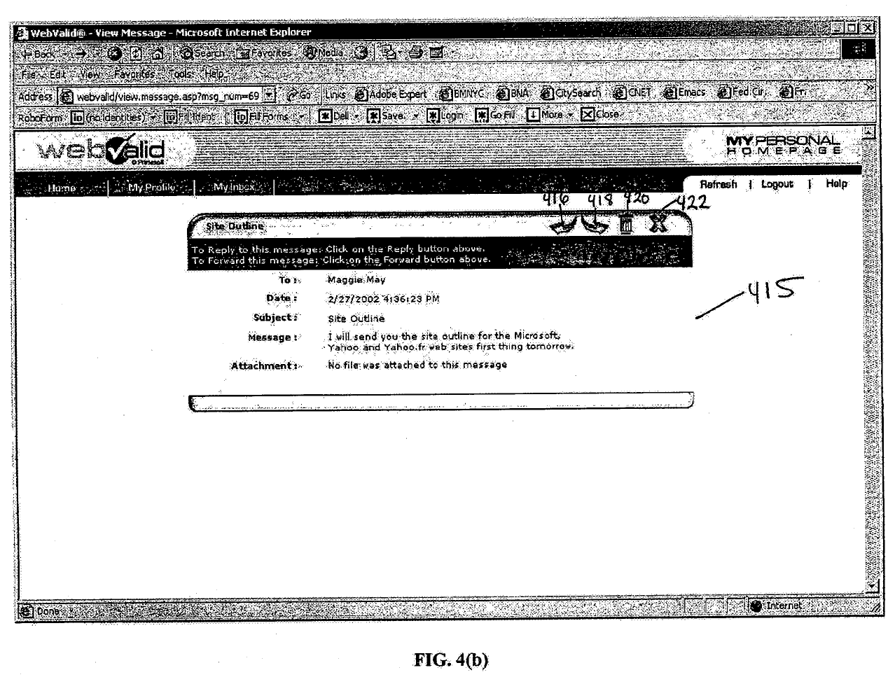

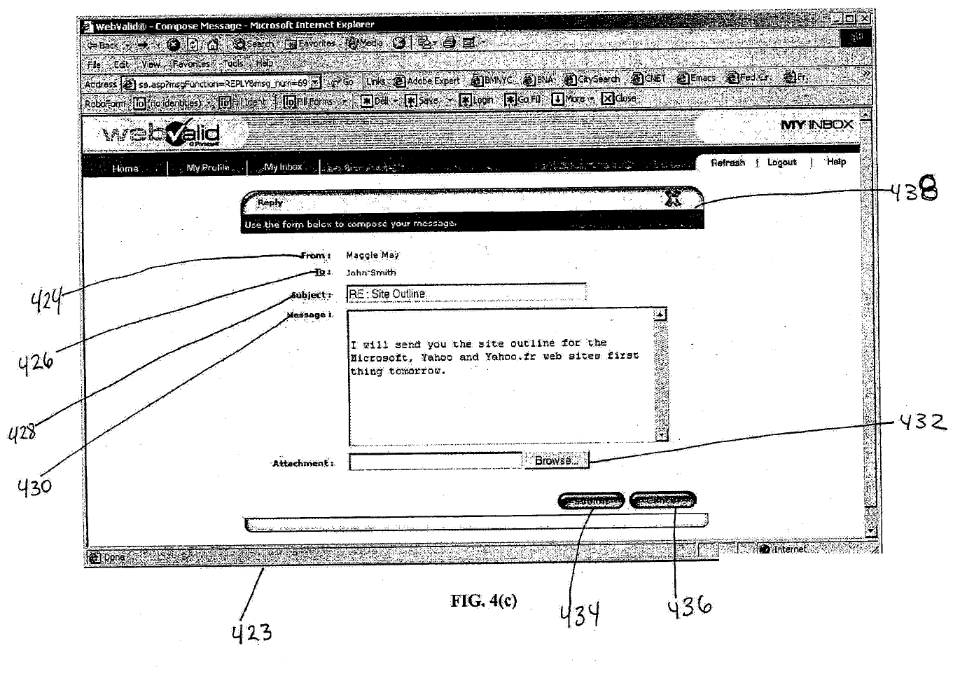

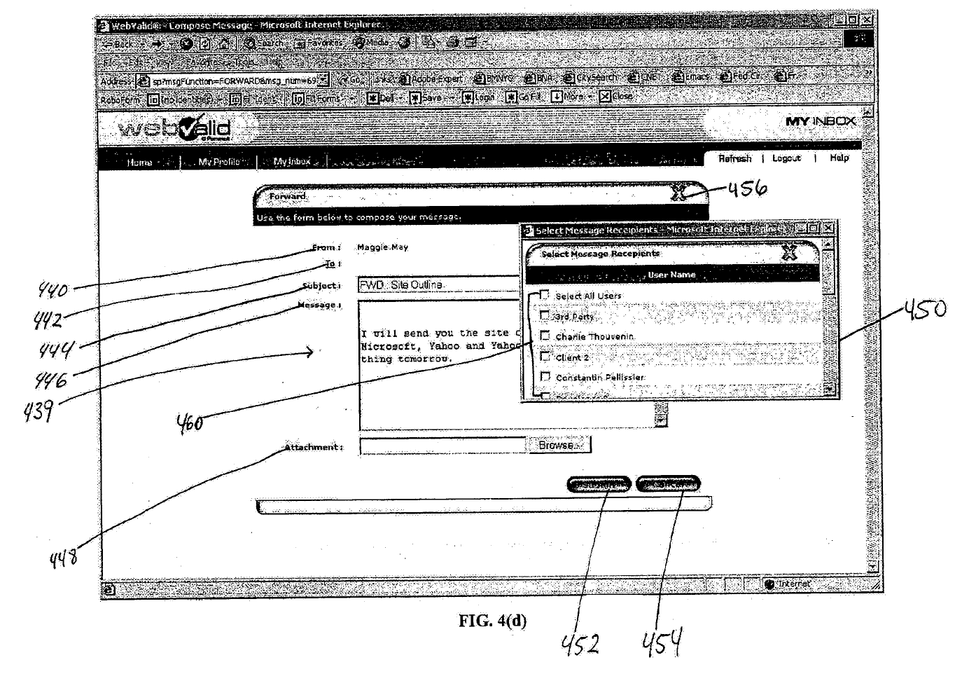

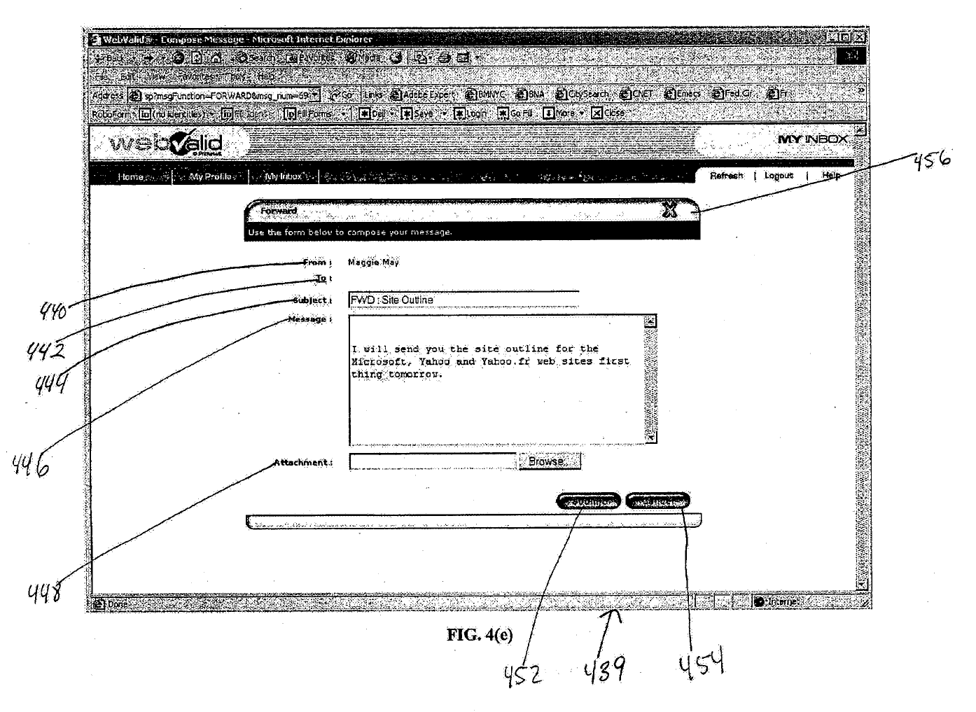

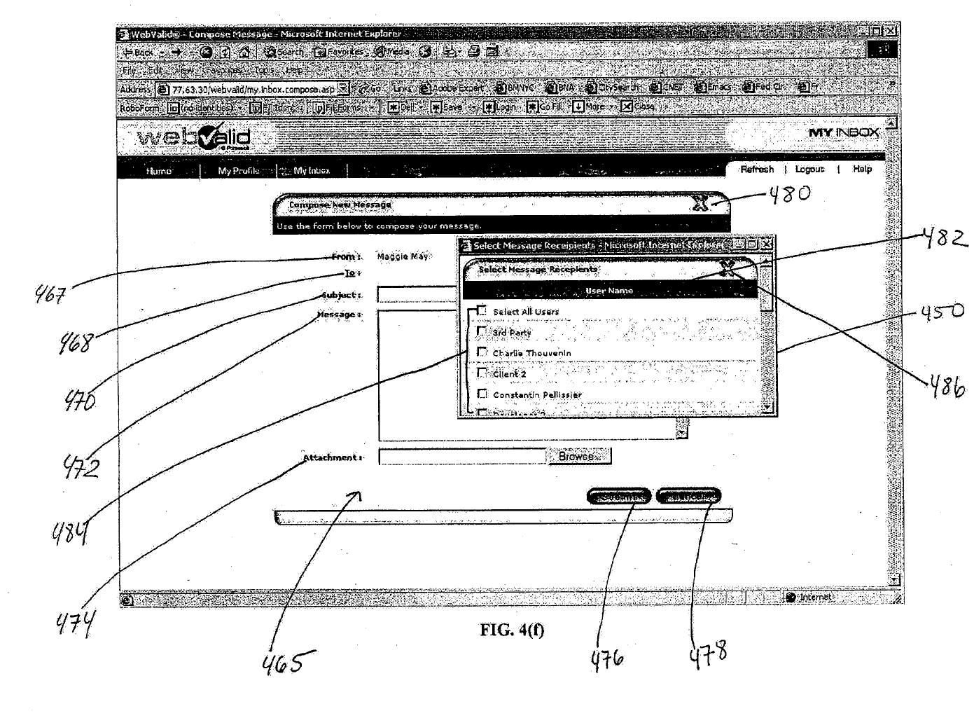

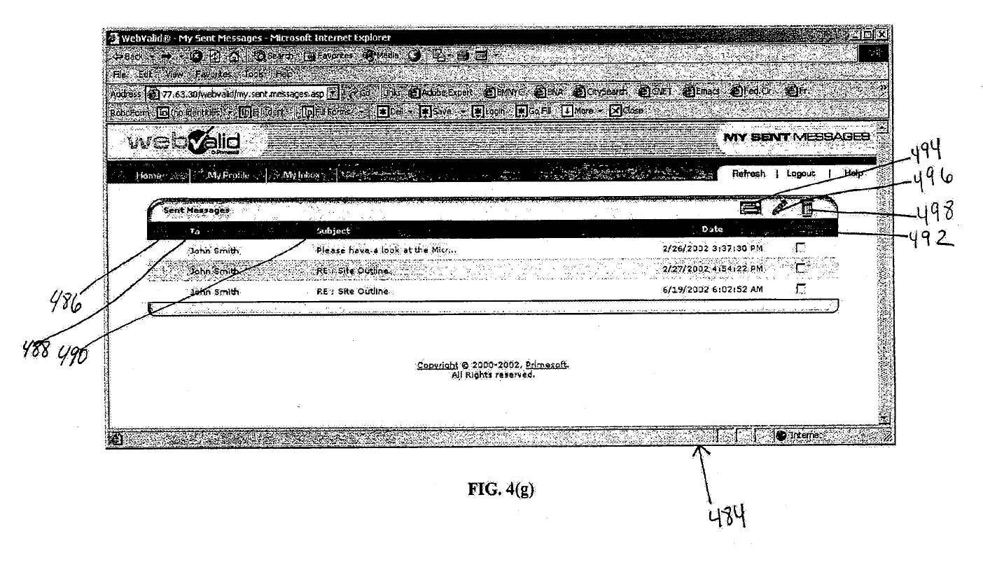

Navigation menu 205 provides several functions. Upon clicking on “Home” button 210 the user is taken back to the “Personal Homepage”, shown in FIG. 2. Clicking on “My Profile” button 215 opens up a “My Profile” window, shown in FIG. 3, that allows the user to access profile management functions to personalize and manage his/her profile. Clicking on “My Inbox” button 220 opens the “My Inbox” window, shown in FIG. 4(a).

To modify User ID, in the “My Profile”, shown in FIG. 3, the user edits the data in “User ID” field 305, and clicks on “Update” button 310. To modify login password, the user edits the data in “Password” field 315 and clicks “Update” button 310. To modify the display name, the user edits the data in “Display Name” field 320 and clicks “Update” 310. To modify or update email, the user edits the data in “E-Mail Address” field 325 and clicks “Update” button 310. To modify viewing properties, the user checks the desired “Viewing Properties” option box 330, and clicks “Update” button 310. To turn on/off instant messaging, the user checks or unchecks box 340, and clicks “Update” button 310. To modify the image quality properties, the user chooses the desired options in frame 345, sets the preferences for “Freez n' Draw” list box 350 and/or sets the preferences for screen capture and other images list box 355, and clicks “Update” button 310. If the user decides to make no changes, the user simply clicks on “Cancel” button 360.

FIG. 4(a) displays “My Inbox” window 400. It also includes buttons 210-220 and 255-265, previously described. A field names bar 401 is displayed with the following button that designates the content of its respective column: “From” button 402, “Subject” button 404 and “Date” button 406. If the user wishes to sort a particular column of “Inbox”, the user simply clicks on one of the buttons 402-406 that the user wishes to sort. On the upper left hand side of the window are the sent messages button 408, compose button 410 and delete selected messages button 412.

If the user wants to read a message, the user clicks on appropriate hyperlink under “Subject” button 404, upon which event a read message window 415 is displayed, shown in FIG. 4(b). The read message window 415 displays a reply test button 416, a “Forward” button 418, a trash button 420, and an “X” button 422. “X” button 422 closes the read message window and opens the prior window displayed, in this case “My Inbox” window 400 shown in FIG. 4(a).

After reading the message, the user has several options. The user may click reply button 416 to reply to the message, upon which event the “Reply” window 423 is displayed, shown in FIG. 4(c). “Reply” window 423 contains several fields including “From” field 424, “To” field 426, “Subject” field 428, “Message” field 430, “Attachment” field 432, “Submit” button 434, “Cancel” button 436, and “X” cancel button 438. After entering the specific data in fields 424-430, the user has the option to attach a file in field 432. If the user does not know the name of the field, the user can click the “Browse” button and, as is well known to those skilled in the art, a standard open file dialog will appear.

Upon fully composing the reply, the user clicks on “submit” button 434 to send the message to the recipients. If the user wishes to cancel the reply option, the user simply clicks on either of “Cancel” buttons 436 or 438.

Referring again to the message window shown in FIG. 4(b), the user may also choose to forward the message. In that case the user clicks button 418, upon which event “Forward” message window 439 appears with a “Select Message Recipients” window 450, as shown in FIG. 4(d). “Select Message Recipients” window 450 includes a “user name” field bar 458, a list of possible recipients 460, and a cancel button 462. “Select Message Recipient” window 450 enables the user to select persons whom will receive the recipients by clicking on the option box 460 next to the particular recipient's name. If the user wishes to cancel the forward process, the user simply clicks on “X” button 462.

“Forward” message window 439 shown most clearly in FIG. 4(e), includes various fields including “From” field 440, “To” field 442, “Subject” field 444, “Message” field 446, “Attachment” field 448. It also includes “Submit” button 452, “Cancel” button 454 and “X” button 456, which activates the cancel function.

While reading the message, as shown in FIG. 4(b), the user may also delete the message from “My Inbox ” window 400 by clicking on trash button 420. The system can also optionally ask for confirmation before the message is actually deleted. To delete multiple messages, the user clicks on “back” button 422. The user may then check or uncheck boxes 414 in “My Inbox” window 400 shown in FIG. 4(a). The checked messages will be deleted upon clicking delete button 412.

To compose or send messages, the user clicks on the compose new message button 410 in “My Inbox” window 400 shown in FIG. 4(a). “Compose New Message” window 465 appears with a “Select Message Recipients” 450 window on top, as shown in FIG. 4(f). Like “Reply” window 423 shown in FIG. 4(c), “Compose New Message” window 465 includes various fields and buttons including “From” field 467, “To” field 468, “Subject” field 470, “Message” field 472, “Attachment” field 448, “Submit” button 474, “Cancel” 478 and “X” button 480, which has a similar function to the “X” buttons described above. To compose/send a message, the user may utilize the same steps outlined above for replying to messages. Clicking on trash button 412 will enable the user to delete messages as discussed above.

While the user is within “My Inbox” window 400 shown in FIG. 4(a), the user may view sent messages by clicking on “Sent” button 408, upon which event “Sent Messages”, window 484, shown in FIG. 4(g), appears. This window includes field bar 486, which has the following fields: “To” field 488, “Subject” field 490 and “Date” field 492. In addition, button 494 that closes “Sent Message” window 484 and opens “My Inbox” window 400, compose a new message button 496, and delete selected messages button 498. The user navigates through “Messages Sent” window 484 in the same manner described for navigation through “My Inbox” window 400.

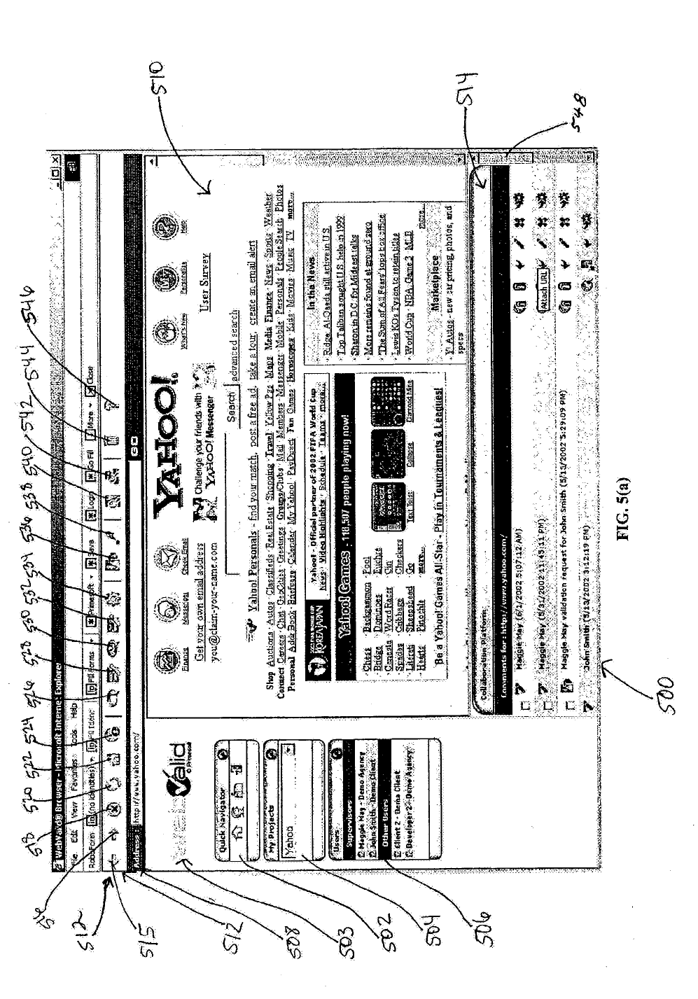

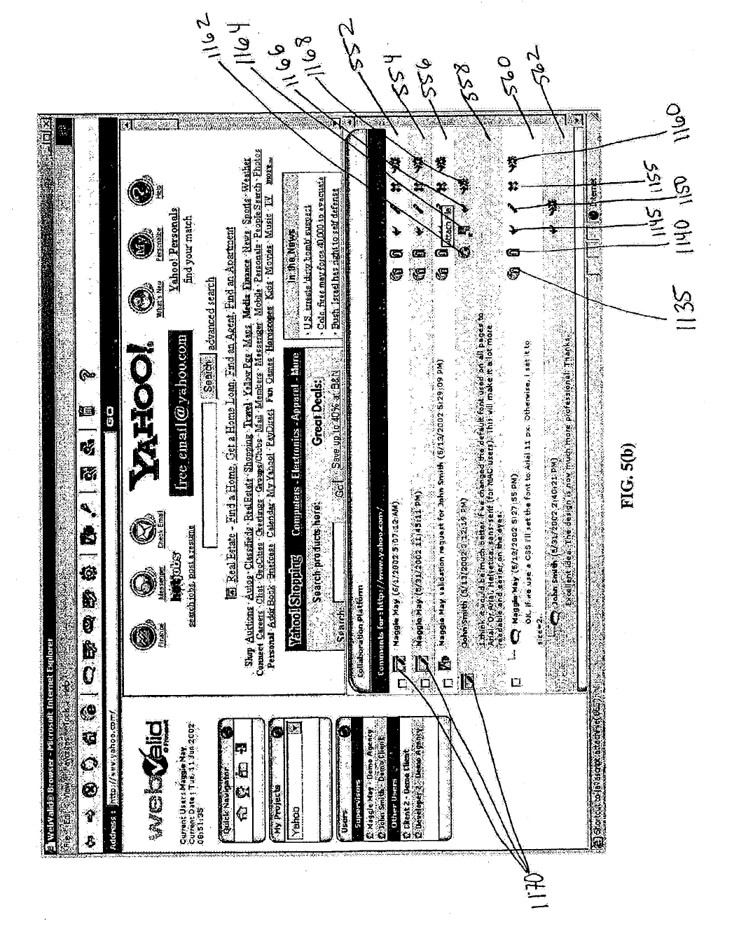

“My Projects” frame 225 in FIG. 2 contains a list of hyperlinks 227 to all the user's current projects. Upon clicking upon a project name, for example “Microsoft” or “Yahoo”, the selected project is loaded in a project window 500, shown in FIGS. 5(a) and 5(b). FIGS. 5(a) and (b) are described in more detail below.

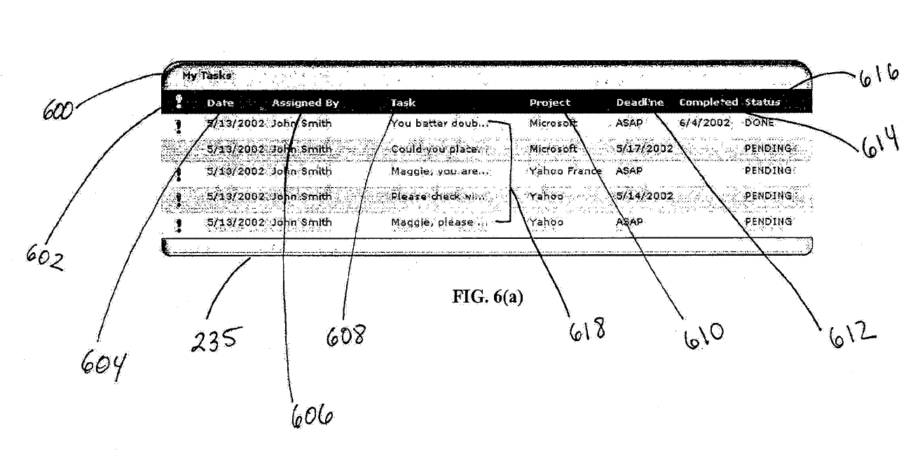

“My Tasks” frame 235 in FIG. 2 lists tasks assigned to the user by other users of the system. As show in more detail in FIG. 6(a) “My Tasks” frame 235 includes a field bar 600, which includes various data fields. The exclamation point column 602 indicates the priority status, which refers to the importance of a particular task. Low indicates the lowest level of importance, normal indicates default level of importance, and high indicates the highest level of importance. “Date” column 604 is the date the task was created. “Assigned By” column 606 indicates the name of the user who assigned a particular task. “Task” column 608 describes the actual task itself. “Project” column 610 is the name of the project to which a particular task is related. “Deadline” column 612 indicates the deadline that was assigned to a particular task when it was created. Deadlines include ASAP (as soon as possible), tomorrow, within 2, 3, or 4 days, and an enter date option which allows user to enter a specific date for a task. “Completed” column 614 indicates the exact date when a task was completed. A task is not considered completed until the user that assigned a task has approved the work done. When that is done, the system automatically files in the completed date. “Status” column 616 indicates the current status of a task, which can be pending, done, or approved.

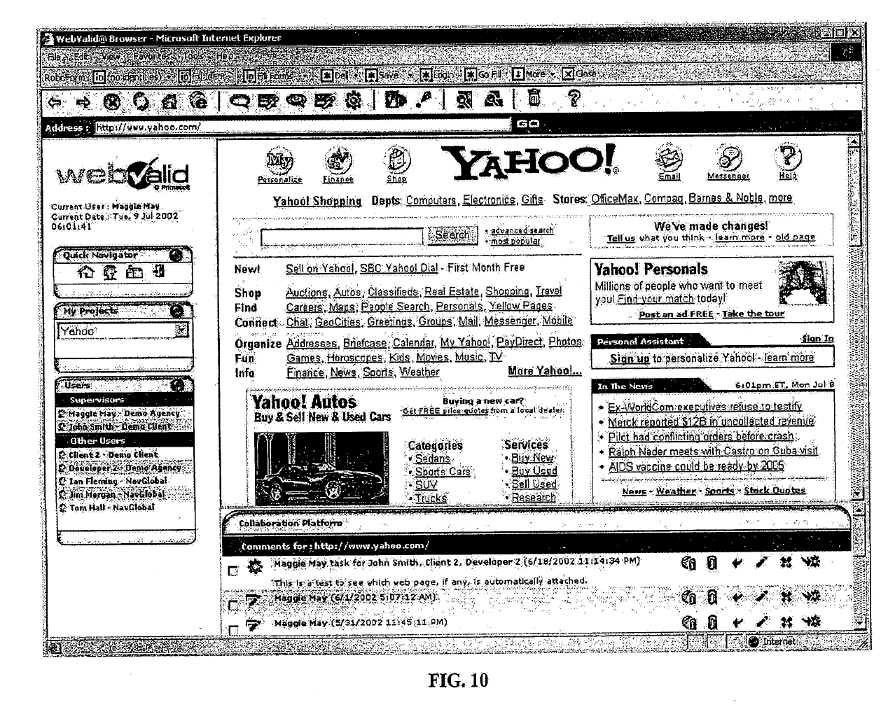

To view the details/properties of an assigned task, the user moves the mouse cursor over one of the description hyperlinks 618 under task 608 and the details of the task will then be displayed. For example, clicking the hyperlink “Please check wi . . . ” in hyperlink 618 will open a new window displaying the associated task and web page graphics as shown in FIG. 10. To view the project to which a particular task has been assigned, the user clicks on a hyperlink under “Project” column 610 and this will open the related project, as discussed above under “My Projects.” Thus, clicking “Yahoo” in the “My Task” frame in FIG. 6(a) open the “Yahoo” in “My Projects” frame, but will display the web page in browser pane 510 that was displayed in the browser pane 510 when the particular task was created, rather than the then active page that would be available, for example, over the internet.

To update the status of a task that has been assigned, the user clicks on the appropriate hyperlink under “Status” column 616. “Confirm Change Status” window, shown in FIG. 6(b), will appear. For example, to change the status the “My Tasks” frame clicking on “Done” in the “Confirm Change Status” window of FIG. 6(b) reverts the status back to “Pending” and vice versa. When the task is marked “Done” in the “My Tasks” frame in FIG. 6(a), the system automatically fills in the appropriate date in “Completed” column 614 in “My Tasks” frame 235.

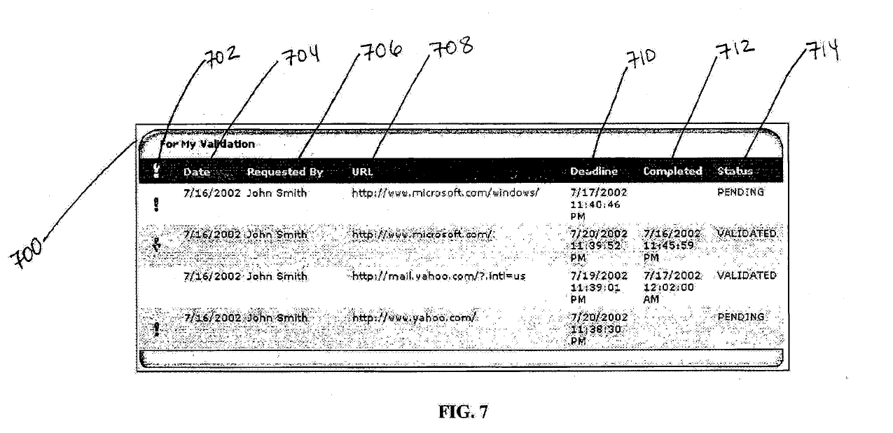

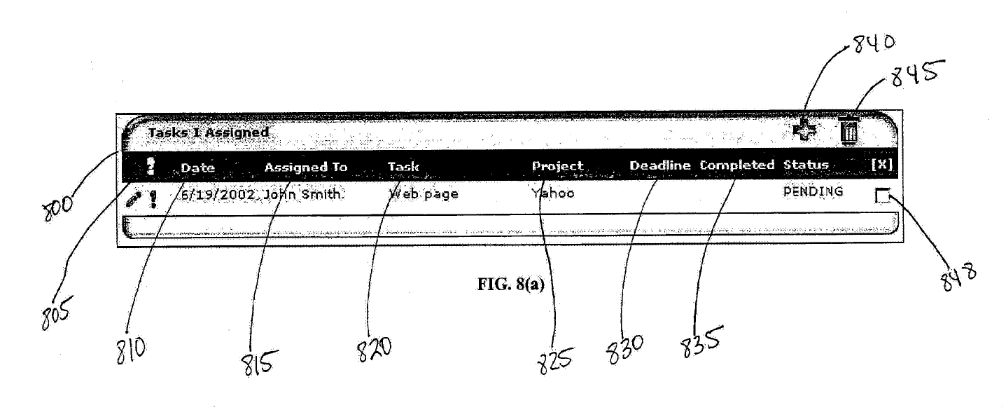

FIG. 7 illustrates in more detail “For My Validation” frame 240 in FIG. 2 that allows the user to view any requests for validation made by other users. “For My Validation” frame 240 includes a field bar 700 which contains various columns, many with similar functions as those discussed above in connection with field bar 600: the exclamation point 702 representing priority status, “Date” column 704, “Requested By” column 706, “URL” 708, “Deadline” column 710, “Completed” column 712 and “Status” column 714. To view the content or the URL that is the subject of the request for validation, the user simply clicks on the hyperlink listed under the URL label 708. To mark the validation request as “Validated” the user clicks on “Pending” under the Status label 714. The status of the “Request for Validation” toggles to “Validated.” In the event that the user needs to revert the status of the request back to “Pending”, the user simply clicks again on “Validated” in the Status column 714.

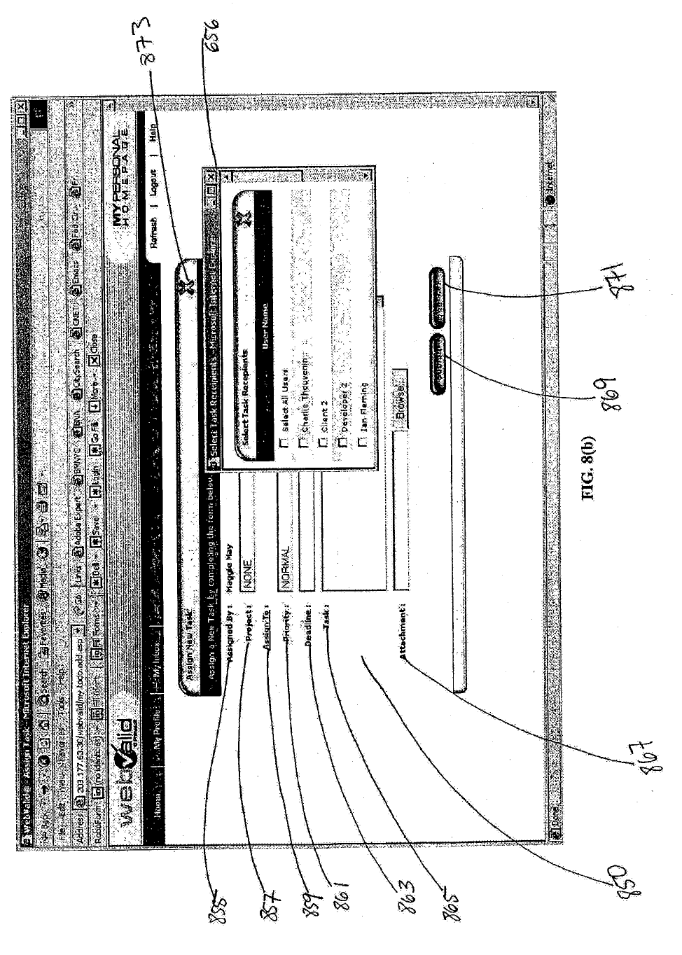

FIG. 8(a) illustrates in more detail “Tasks I Assigned” frame 245 shown in FIG. 2, which provides the user with a complete listing of the tasks the user has assigned to other users. The field bar 800 includes the same data fields as in “For My Validation” window 240, in addition to three more fields. There is an assign new task button 840, a delete selected assigned tasks button 845, and check boxes 848 to select tasks to be deleted.

To assign a new task, the user clicks on button 840, over which event an “Assign New Task” window opens 850, as shown in FIG. 8(b), upon which a “Select Task Recipients” window 855 opens. “Select Task Recipients” window 855 operates similarly to “Select Message Recipients” window 450 described above.

“Assign New Task” window 850 contains the following fields: “Assigned By” field 855, “Project” field 857, “Assign To” field 859, “Priority” field 861, “Deadline” field 863, “Task” field 865, and “Attachment” field 867. After completing the details of the task the user clicks “Submit” button 869. Alternatively, the user can click “Cancel” button 871 to close “Task” window. The user may also cancel the window by clicking on “X” button 873 in the upper right hand comer. To delete an assigned task in FIG. 8(a), the user checks boxes 848 next to the task to be deleted and then clicks trash can button 845.

Upon completion of the assigning a new task, the system captures the then active web page and associates that web page with the task that the user has created. Thus, when that task is later accessed, a web page opens in browser pane 510 as described above.

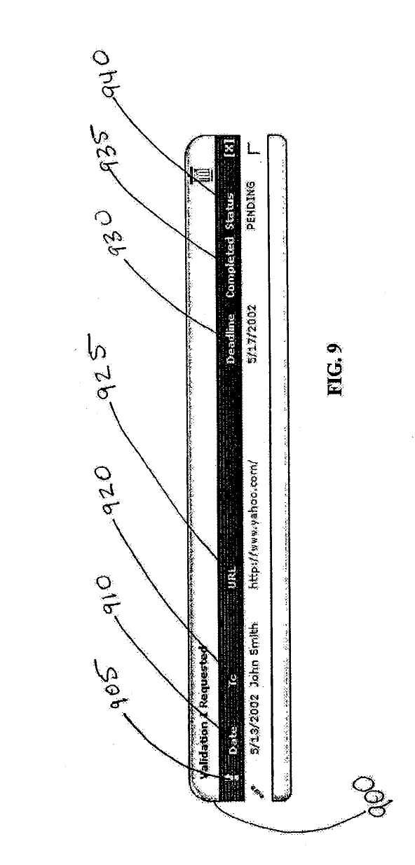

FIG. 9 illustrates in more detail “Validations I Requested” frame 250 of FIG. 2. “Validations I Requested” frame 250 provides a listing of validation requests that the user has sent to other users. The window contains a field bar 900 with the same data columns and buttons as discussed above.

FIG. 5(a) illustrates ‘Project” page 500 in which a particular project is collaborated or worked. It can also be thought of as the “work area.” “Project” page 500 is composed of three main areas or panes: control pane 503, browser pane 510 and “Collaboration Platform” pane 514. As is well known to those skilled in the art by dragging the border between the panes, each of the panes in “Project” window 500 can be enlarged or diminished at the expense or benefit of the adjoining panes.

The control pane 503 includes: a “Quick Navigator” 502 frame which provides quick access buttons to the user's “Personal Homepage” window 200 shown in FIG. 2, “My Profile” window 300 shown in FIG. 3, “My Inbox” window 400 shown in FIG. 4, and logout button. Control pane 503 also includes “My Projects” 504 frame which provides drop down list having a list of active projects to permit the user to navigate to other available projects as discussed above; and “Users” frame 506 which provides an alphabetical listing of project supervisors, owners, and members for the particular project.

The browser pane 510 is the area in which a web page, for example, the Yahoo! home page, that is to be modified, is loaded and displayed. To load a web page into the browser pane, a user enters into address bar 508 the URL of the web page the user desires to modify or comment upon. Thus, address bar 508 displays the URL of the current page that is loaded in the browser pane 510.

“Tool Bar” menu 512 contains quick access buttons to all of the collaboration tools and functions. Tool bar 512 contains quick access buttons to all of the browsing and collaboration tools and functions. In the illustrated embodiment these tools and functions can also be accessed via keyboard shortcuts. The back button 515 functions like the back button of a browser. The forward button 516 functions like the forward button of a browser. Stop button 518 functions like the stop button of a browser and stops the current page from loading. Refresh button 520 functions like the refresh button of a browser and reloads the current page loaded in the browser window. The home button 522 loads the home page of the selected projected in the browser window. The Open Current Window in the New IE Window 524 button opens the current page in a new IE browser window. The add comment button 526 provides access to the comment tools and functions.

A person skilled in the art will recognize from the description of tool bar 512 and browserpane 510, and the interaction between these two objects, “Project” window 500 acts so to speak as a browser within a browser. That is, within the outer “Project” window 500, which is essentially an Internet browser accessing the method and system described in this specification, there is a second browser comprising browser pane 510 and tool bar 512.

“Collaboration Platform” pane 514 is the area in which all collaboration on a given project takes place. Because of the arrangement of the panes in “Project” window 500 in FIG. 5(a) and the size of the display area on a particular monitor, not all of “Collaboration Platform” pane 514 may be visible. One skilled in the art will readily recognize that by moving slider 548 other portions of the content in “Collaboration Platform” pane 514 can be brought into view. Alternatively, as described above, if the border between “Collaboration Platform” pane 514 and browser pane 510 is dragged vertically, more of “Collaboration Platform” pane 514 becomes visible and less of browser pane 510 is visible.

FIG. 5(b) shows “Project” window 500 with all of the content in “Collaboration Platform” pane 514 visible. It contains a list of comments 552-562. Each of the user's own comments is followed by a set of buttons that activate various functions and each of which is preceded by one of a number of different buttons or icons. URL button 1135 permits the user to load a window that displays the page associated with the comment. Attach file button 1140 activates an attach file dialog (not shown) that permits the user to attach to the user's comment a file. Reply button 1145 opens a field that enables the user to insert a reply to the comment. Edit button 1150 allows the user to add a comment and is discussed below. Delete button 1155 permits the user to delete the comment and forward as a task button 1160 opens a dialog that permits the user to send the comment to another user as a task.

Comments from other users contain yet different buttons after the comments. View attached URL button 1162 permits the user to view the URL associated with the comment. Download attached file button 1164 allows the user to download the file associated with the comment. Reply button 1166 opens a field and appropriate buttons to permit the user to reply to a comment. Comment 560 is just such a reply to comment 558. Forward as task button 1168 opens a dialog that permits the user to forward the comment as a task to other users.

Similarly, preceding the text in each comment are other buttons and icons. For example, in comments 552, 554, and 558 View Freez n' Draw buttons 1170 are found. Clicking this button opens a window that displays the URL that a user had frozen and marked-up. Found in comment 556 is icon 1172 that indicates the comment is a request for validation.

Also found in FIG. 5 Freez n' Draw button 528 provides access to the Freez n' Draw tools and functions described more fully below. The private comment button 530 provides access to the private comment tools and functions. “Private Freez n' Draw” button 532 provides access to the private Freez n' Draw tools and functions. The assign task button 534 provides access to the task functions and tools and allows the user to assign a task to other users for the current active page or project. The request validation for this page button 536 allows the user to send a validation request for the current page to other users. The send e-mail notification button 538 allows the user to send an e-mail notification for the current page to other users. The view page status button 540 provides access to the status report for the currently active page. The view site status button 542 provides access to the status report for all the pages in the project then active. The delete selected comments button 544 is used for deleting multiple comments, tasks, validation requests, Freez n' Draw comments, etc. “Help” button 546 provides quick access to the on-line help.

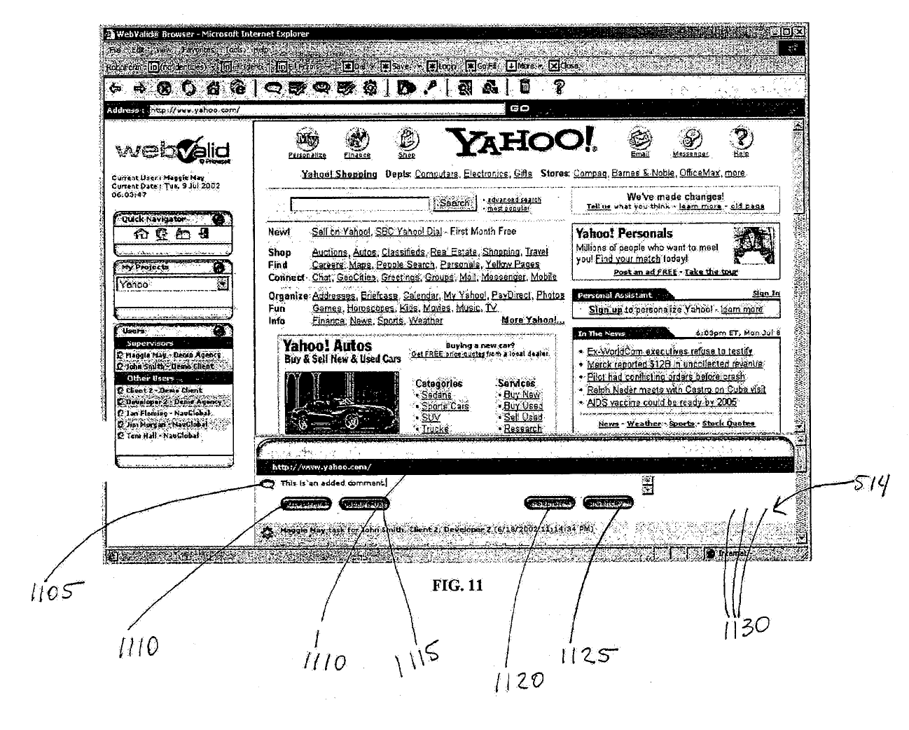

There are two standard comments features within “Collaboration Platform” pane 514: standard comments and editing comments. To create a standard comment, assuming the user had navigated to “Project” window 500 for the project on which the user wishes to comment, the user clicks on the add comment button 526 on the browser toolbar 512 to change “Collaboration Platform” pane 514 to appear as shown in FIG. 11.

As shown in FIG. 11 “Collaboration” pane 514 contains several new widgets including: the specific web page label 1100 which is the subject of the comment, a comment field 1105, a file attachment field 1110, a “Capture URL” button 1115, a “Submit” button 1120, a “Cancel” button 1125 and a list 1130 of prior items. The user writes the comment in field 1105 and clicks on submit 1115. To cancel the operation, the user simply clicks on “Cancel” button 1125.

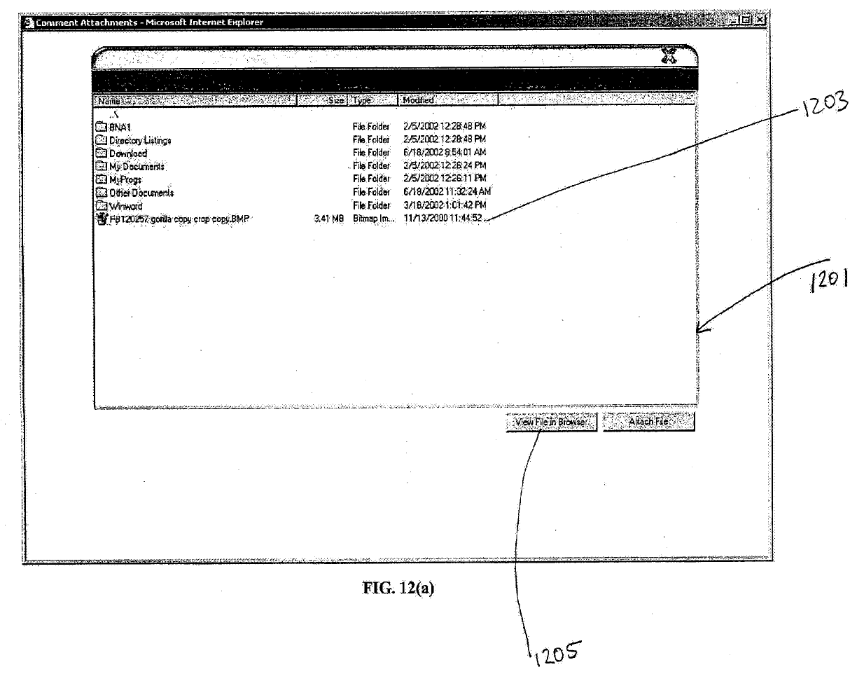

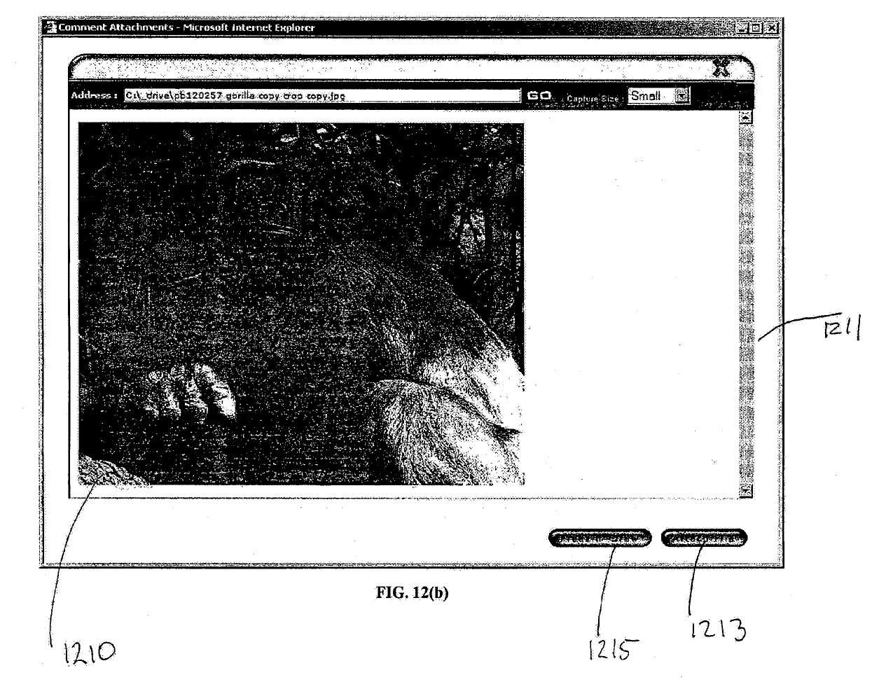

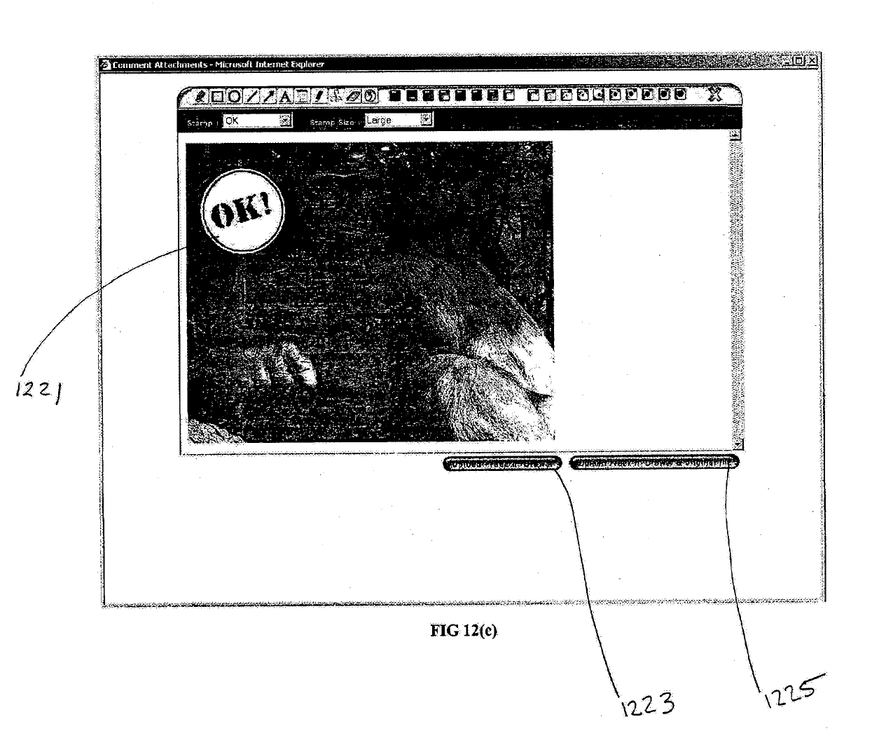

To attach a file, the user clicks on “File Attachment” button 1110. A file dialog window 1201 opens which enables the user to navigate to a file 1203 on the hard disk, as shown in FIG. 12(a). Double clicking on the file name or on “View File in Browser” button 1205 loads the image 1210 in the file into browser window 1211 as show in FIG. 12(b). The user has then the option to either attach the file to the comment by clicking “Attach File” button 1213 or marking the image through the Freez n' Draw tools by click “Freez n' Draw” button 1215.

Clicking “Freez n' Draw” button 1215 loads the Freez n' Draw tools as shown in FIG. 12(c). In addition to showing the Freez n' Draw tools, FIG. 12(c) illustrates the use of the stamp tool to place on the image the “OK” stamp 1221. The user then has a choice. The user can click “Upload Freez n' Draw” button 1223 to upload the marked up Freez n' Draw image 1210 to be displayed in browser pane 510 when the comment is selected. Or the user can click “Upload Freez n' Draw & original file” button 1225. Doing so uploads and attaches the original file to the comment and also uploads the marked up Freez n' Draw image 1210 to be displayed in browser pane 510 when the associated comment is selected.

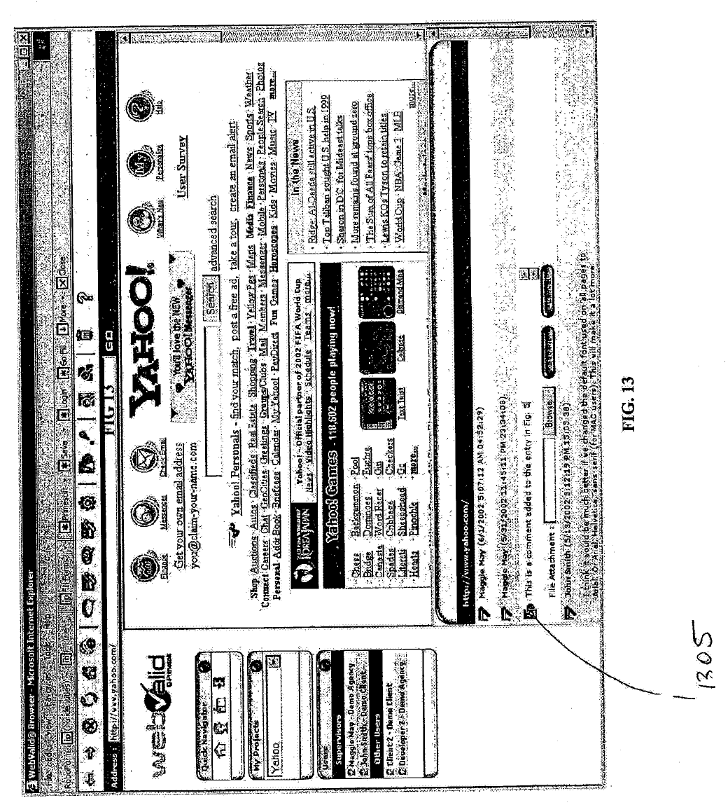

The user who creates a standard comment may edit the comment on “Project” page 500. To so edit the standard comment the user navigates to the comment upon which the user wishes to act within “Collaboration Platform” pane 514, and clicks on the appropriate button to the right of each entry. For example, referring to FIG. 5 edit button 1150 permits the user to make changes to the standard comment. When a user clicks on edit button 1150 in third entry from the top in “Collaboration Platform” pane 514, a comment field 1305 appears as shown in FIG. 13. For purposes of illustration the comment “This is a comment added to the entry in FIG. 5” has been added to FIG. 13.

Similarly, to reply to a standard comment, the user navigates to the desired standard comment in “Collaboration Platform” pane 514, clicks on the reply button 1145, and composes the reply. To forward a standard comment as a task, the user navigates to the desired standard comment, clicks on the forward button 1160 and follows the steps discussed above for working with tasks.

The user may also create private comments, which cannot be viewed by all users, by clicking on private comment button 530. Private comments can only be viewed/read by their intended recipients. The steps to use the private comment function are the same as those discussed above for standard comments using button 524.

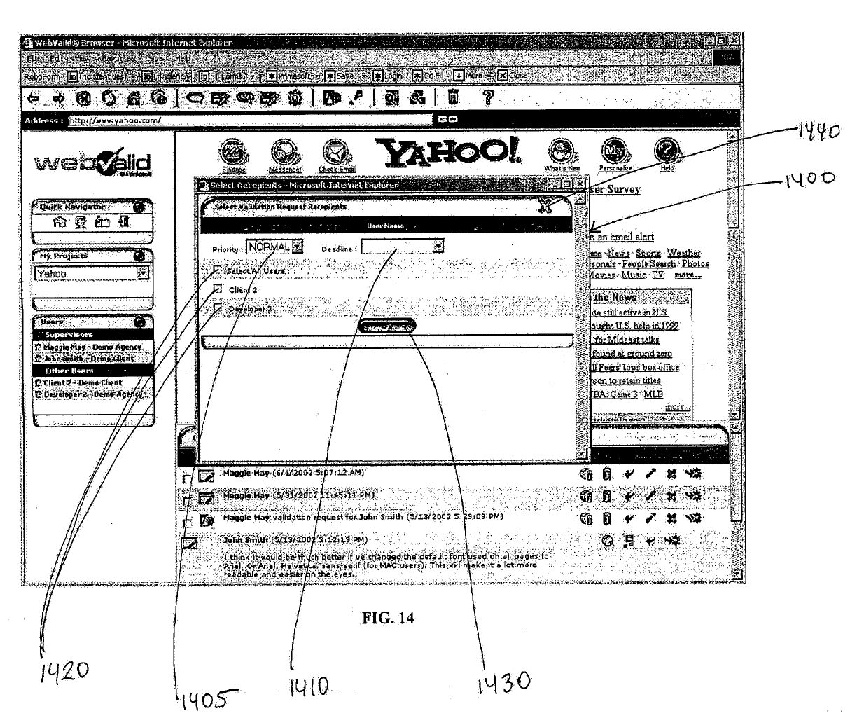

The validation request function allows users to request that specific pages or web content be “validated” by other users. To make a validation request, the user clicks on request validation for this page button 536. “Select Validation Request Recipients” window 1400 then opens on top of “Projects” window 500 as shown in FIG. 14. “Select Validation Request Recipients” window 1400 has the following fields and buttons: priority status field 1405, deadline field 1410, username check boxes 1420, an “OK” button 1430, and “X” cancel button 1440. “Select Validation Request Recipients” window 1400 is used similarly to window 450, as described above.

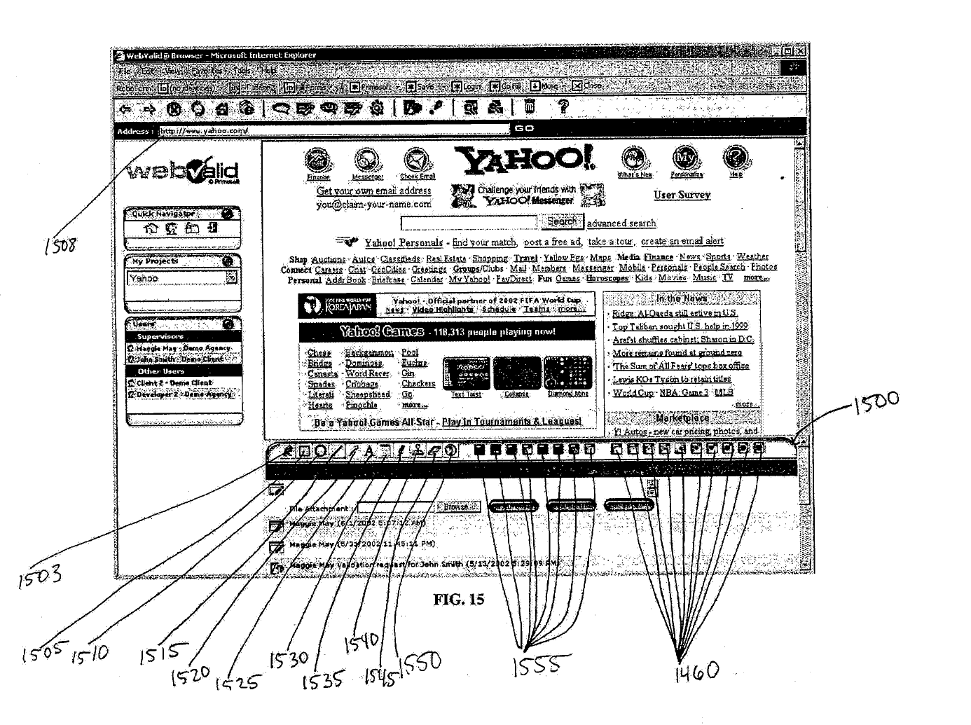

A user activates the Freez n' Draw feature by clicking on Freez n' Draw button 528. To create a Freez n' Draw comment, the user loads into the browser pane the web page upon which he wishes to make a Freez n' Draw comment and clicks “Freez n' Draw button 528. That opens Freez n' Draw toolbar 1500 inside “Collaboration Platform” pane 514, as show in FIG. 15. Freez n' Draw toolbar 1500 contains buttons for various functions: pen button 1503, square button 1505, circle button 1510, line button 1515, arrow button 1520, text button 1525, note button 1530, highlighter button 1535, stamp button 1540, eraser button 1545, reset button 1550, color selection buttons 1555, and font size selection buttons 1560.

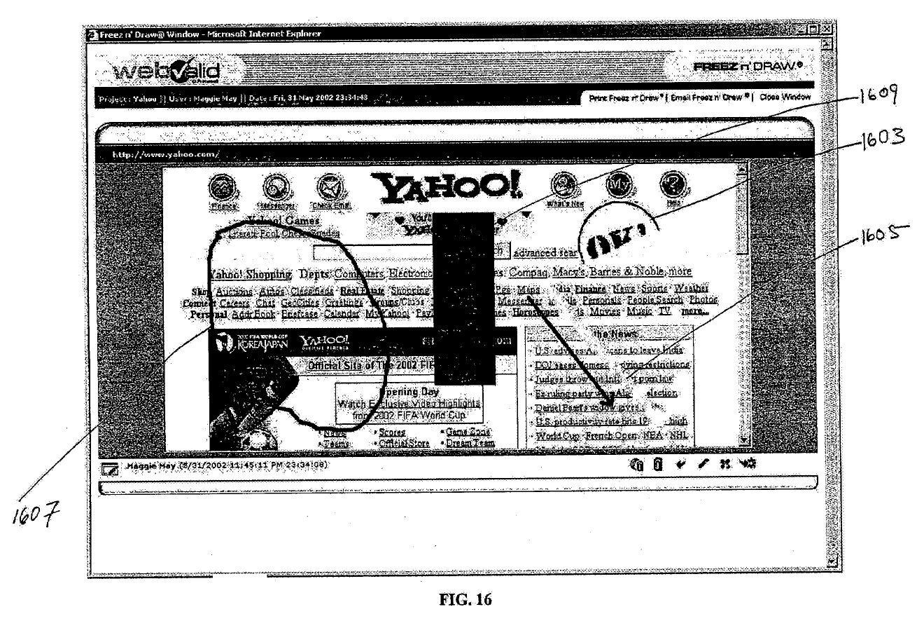

A person skilled in the art readily recognizes the use and function of each of the buttons on toolbar 1500. FIG. 16 illustrates a few of the mark-ups that can be drawn within the browser pane 510 using the Freez n' Draw toolbar 1500. For example, the mark-up in FIG. 16 includes “OK” stamp 1603 that was subsequently partially erased, lines 1605 of varying width and color having an arrowhead at one end, hand drawn circle 1607 and rectangle 1609.

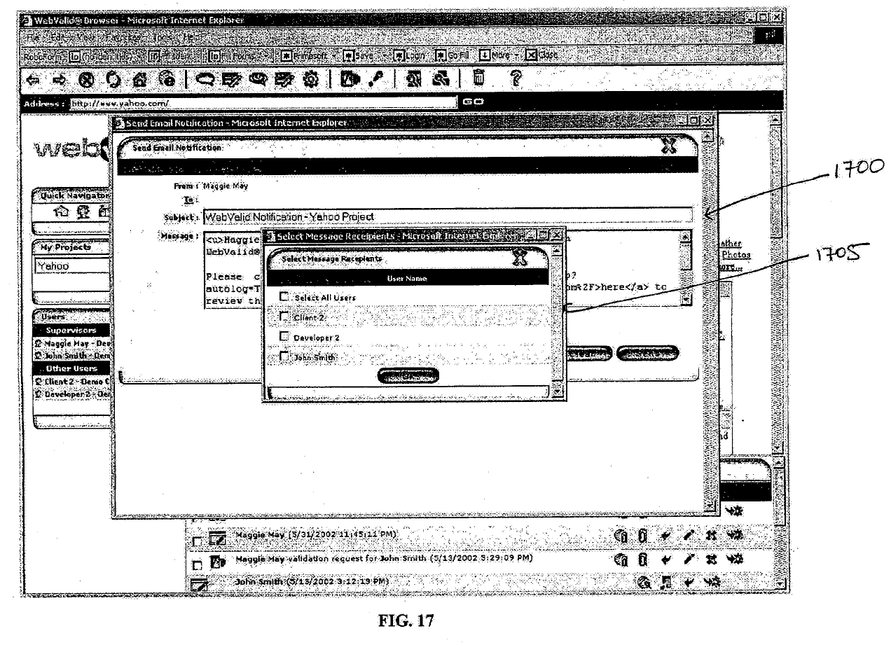

Users also may send email notifications to registered project users informing them that they have made comments or other collaboration events to a project by clicking on the email notification button 538 on the collaboration tools and functions bar 512 in FIG. 5. As shown in FIG. 17 “Send Email Notification” window 1700 and “Select Message Recipients” window 1705 opens. As described above for analogous dialog windows, the user first selects the recipients, closes “Select Message Recipients” window 1705, and then composes the email notification screen. After entering the personal message, the user may send the message.

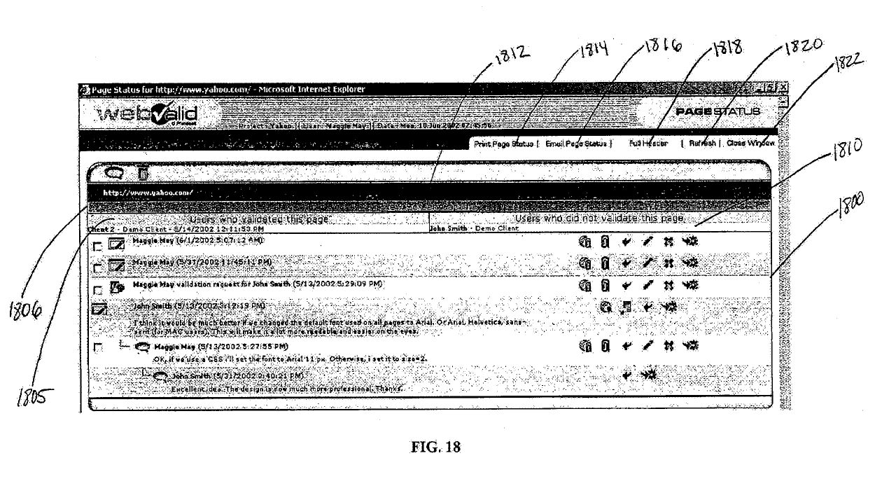

A user can also generate a status report of a particular page in the project or all the projects by clicking either on view page status button 540 or view site status button 542, respectively. FIG. 18 illustrates a page status report 1800 that reports on the complete status of an individual page. The status report includes the following information, among other information: the user(s) who validated the page, including date and time of validation field 1805, the user(s) who did not validate the page field 1810, and URL of the page field 1806. In addition, there is a “View Screen Capture” button 1812, the operation of which is described below, a “Print Page Status” button 1814, an “Email Page Status” button 1816 to send a copy of the report via email, a “Full Header” button 1818, a “Refresh” button 1820, and a “Close Window” button 1822.

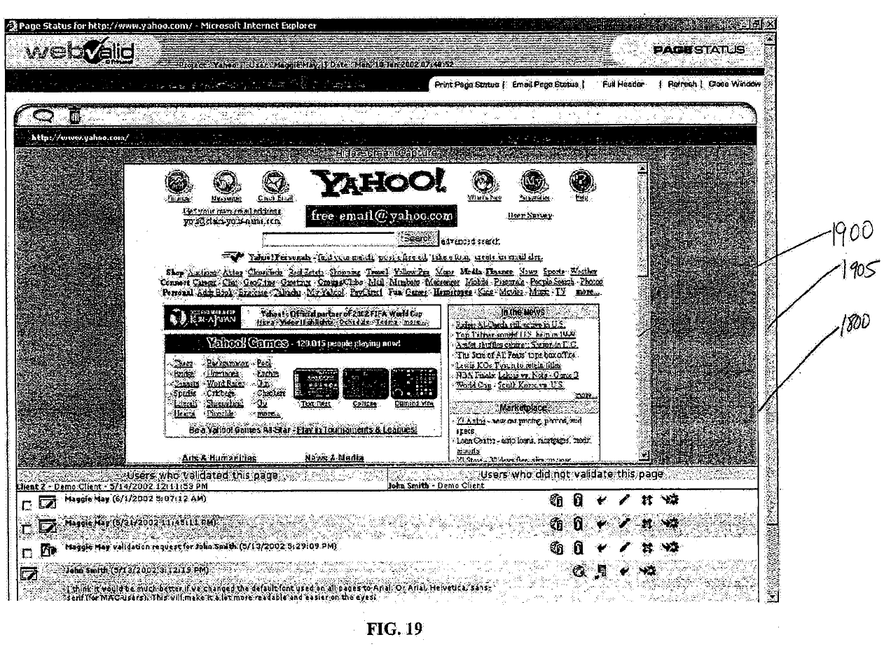

If the user clicks on “View Screen Capture” button 1812, page status report 1800 is repainted to include the image of web page 1900 upon which the status is being reported, as shown in FIG. 19. Since the screen from which FIG. 19 was captured is not sufficiently large to show simultaneously both web page 1900 and all the comments, etc., a scroll bar 1905 appears at the right margin of the page status report 1800 to enable the user to scroll to portion of the report not visible.

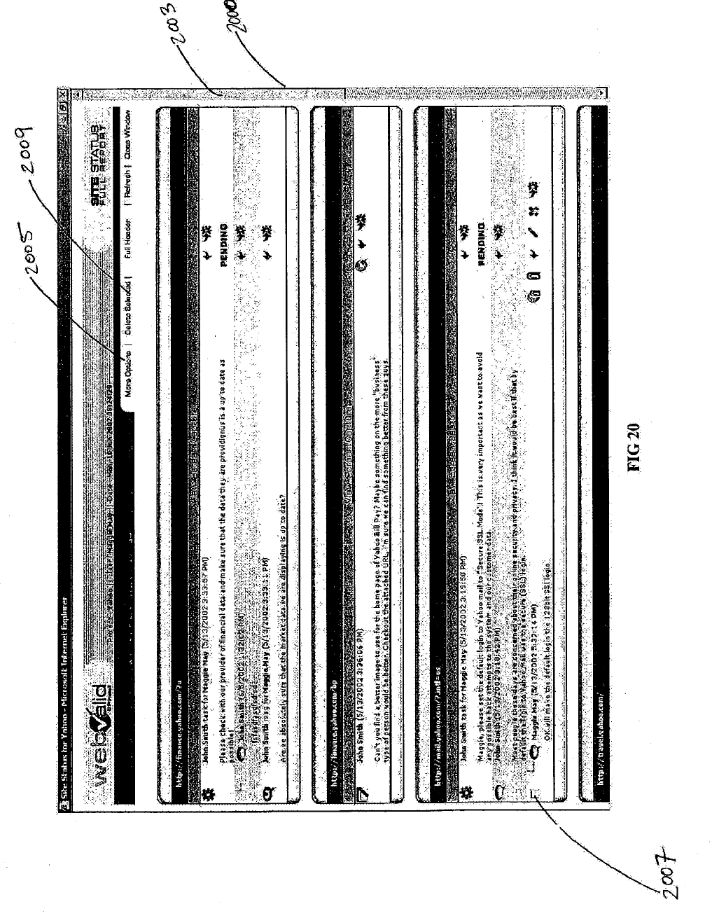

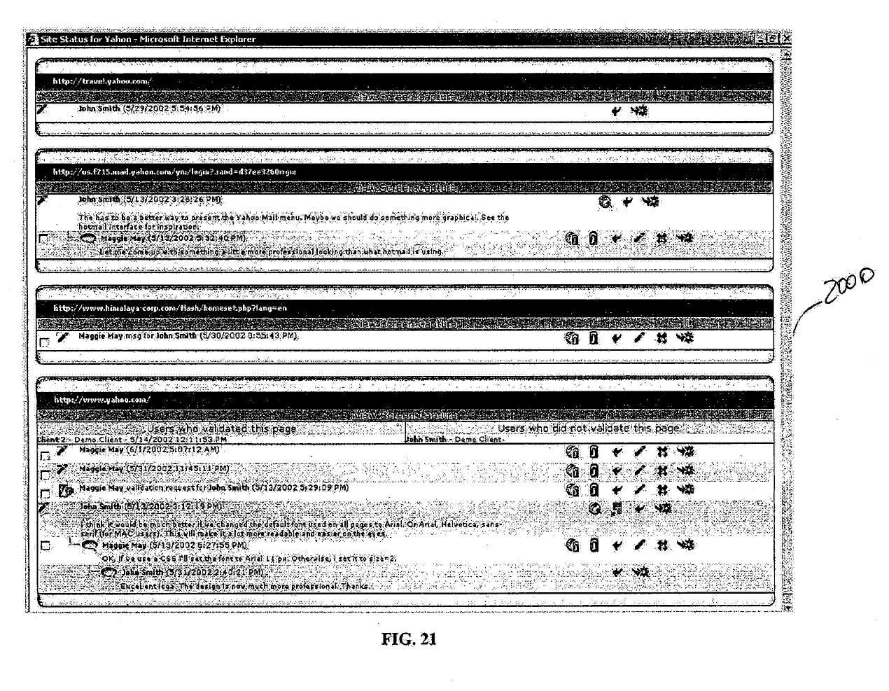

If the user clicks upon view site status button 542 in FIG. 5, a new window displays “Site Status” report 2000. As is evident from the presence of scroll bar 2003, the report “Site Status” 2000 shown in FIG. 20 is too large to fit on one screen. Accordingly, it is captured in two figures, FIGS. 20 and 21 (a portion of the report is repeated on both figures). “Site Status” report 2000 reflects the status for every page in the project active at the time view site status button 542 was clicked, and for each page includes the same information that “Page Status” report 1900 includes. For example, there is a “View Screen Capture” button 192 for each page, and if user clicks on that button, “Site Status” report 2000 is repainted to include the image of the associated page.

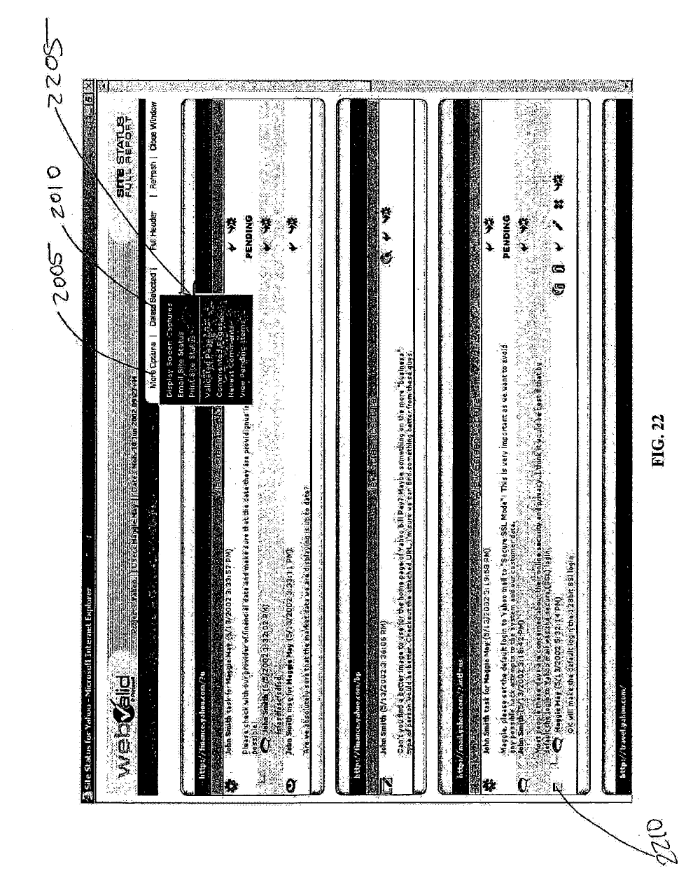

To sort pages in the “Site Status” report 2000 according to those that have been validated, the user clicks on “more options” button 2005. Drop down menu 2105 appears, as show in FIG. 22. Drop down menu 2205 includes the following options: display screen captures, email site status, print site status, validated pages, commented pages, newest comments, and view pending items. Each of the items on drop down menu 2205 works as a person of ordinary skill in the art would expect. For example, the user may filter the pages according to validated, commented, newest or pending.

The user may also delete any of user's comments. To delete any comment, the user clicks on the check box next to a comment that that user made, i.e., check box 2007. The selected comments are deleted when the user clicks “Deleted Selected” button 2009. To respond to any comments within the status reports, the user follows the same steps discussed above for “Collaboration Platform” pane 514.

Although the description of the system and method herein has been presented in the context of a server located on the World Wide Web and using HTTP transactions, other network arrangements and protocols are equally evident to those skilled in the art. Thus, while the present invention has been described with reference to several embodiments thereof, those skilled in the art will recognize various changes that may be made without departing from the spirit and scope of the claimed invention. Accordingly, this invention is not limited to what is shown in the drawings and described in the specification but only as indicated in the appended claims.

We claim:

1. A method for developing web sites through collaborative interaction, including the steps of:
Loading a web page located on a remote server;
Freezing the web page into an image;
Making revisions to the image; and
Storing the revised image on other than on said remote server.

2. A method for developing web sites through collaborative interaction, including the steps of:
a. providing a server from which a web page can be accessed;
b. permitting a first user to select a particular page available on a network;
c. freezing the web page into an image;
d. creating a first record containing at least an identification of the first user;
e. permitting the first user to modify the content of the image;
f. attaching the modified image to the first record; and
g. storing the first record.

3. A method as in claim 2, where the modifications to the image includes at least one of the following: textual comments or graphic revisions to the web page.

4. A method as in claim 2 wherein the only web page stored in the first record is the graphically revised by the first user.

5. A method as in claim 2, including the steps of:
a. providing access to the first record over a network to at least a second user;
b. creating a second record containing at least an identification of the second user; and
c. permitting the second user to modify the image attached to said first record;
d. attaching the image modified by second user to the second record; and
e. storing the second record.

6. A method as in claim 5, including the steps of:
a. providing access to both said first and second records over a network to other users.

7. A method as in claim 5 including:
a. displaying on a single page the at least two or more of said records.

8. A method as in claim 7, including:
a. displaying the image and textual comments in each record.

9. A method for providing a collaborative environment including:
a. providing access to at least one document containing graphical content;
b. permitting an user to load the document into a browser window;
c. allowing the user to alter the content of the document while in the browser window;

10. A method as in claim 9 including storing the altered document for later access by at that user or at least one other user.

11. A method as in claim 9 including providing the user tools to alter the content of the document while in the browser window.

12. A method as in claim 10 including attaching the altered document to a record stored on a server to which is attached a static image of a web page.

13. A method for providing a summary of records containing both textual content and graphical content, including:
a. storing records at least one of which contains both textual and graphical content; and
b. providing on a single page a listing of the textual content of each of the records.

14. A method as in claim 13 including:
a. associating with the textual content of each record a button; and
b. displaying the graphical content of that record upon activation of that button.

15. A method as in claim 13 including:
a. associating with the page a button; and
b. displaying the graphical content of each record on that page upon activation of that button.

16. A method for collaborative interaction, including the steps of:
a. providing a server from which a first user can select a document that contains at least graphical information;
b. providing a static image of that document;
c. creating a first record containing at least an identification of the first user;
d. permitting the first user to modify the content of the image;
e. attaching the modified image to the first record; and
f. storing the first record.

17. A method as in claim 16 including:
a. permitting a second user to access the first record and review at least the static image;
b. allowing the second user to create a second record that contains at least graphical content or textual content; and
c. storing the second record.

18. A method as in claim 17 including
a. permitting the second user to copy the static image attached to the first record;
b. allowing the second user to modify the copied static image; and
c. attaching the modified copied static image to the second record.

19. A system for collaboration including:
a. a server that provides a web page over a network that can be displayed in a web browser at a remote location,
b. said web page capable of display at least two records relating to a single project, at least one of the records capable of containing graphical content relating to that project; and
c. said web page additionally contains a browser window that can navigate to any site on the network.

20. A system as in claim 19 wherein the server can capture the web page displayed in the browser window on the web page in a static image and attach that static image to a third record to be displayed on the web page.
